(19) United States
(12) Patent Application Publication
(10) Pub. No.: US 2022/0038889 A1
(43) Pub. Date: Feb. 3, 2022

(54) USER EQUIPMENT AND METHOD FOR SELECTING A PUBLIC LAND MOBILE NETWORK

(71) Applicant: GUANGDONG OPPO MOBILE TELECOMMUNICATIONS CORP., LTD., Dongguan (CN)

(72) Inventor: Jianhua Liu, Dongguan (CN)

(73) Assignee: GUANDGONG OPPO MOBILE TELECOMMUNICATIONS CORP., LTD., Dongguan (CN)

(21) Appl. No.: 17/472,054

(22) Filed: Sep. 10, 2021

Related U.S. Application Data
(63) Continuation of application No. PCT/CN2019/079917, filed on Mar. 27, 2019.

(51) Int. Cl. H04W 8/28; H04W 48/18

(52) U.S. Cl. CPC H04W 8/28; H04W 84/042; H04W 48/18

(57) ABSTRACT

A user equipment and a method for selecting a public land mobile network (PLMN) are provided. The method includes performing a PLMN selection, wherein the PLMN selection is configured to be used in a standalone non-public network (SNPN), obtaining at least one mobile country code (MCC) from a wireless communication service provider according to the PLMN selection for the SNPN, and storing the at least one MCC.

### CROSS-REFERENCE TO RELATED APPLICATIONS

This application is a continuation of International Application No. PCT/CN2019/079917, filed on Mar. 27, 2019, which is hereby incorporated by reference in its entirety.

### TECHNICAL FIELD

The present disclosure relates to the field of communication systems, and more particularly, to a user equipment and a method for selecting a public land mobile network (PLMN).

### BACKGROUND

In long term evolution (LTE) and new radio (NR) systems, a public network system, such as, a public land network based on public land mobile network (PLMN), is usually deployed. However, in some scenarios, such as offices, homes, and factories, in order to be more effective and securely managed, local users or administrators usually lay out a local network. Members in a local network group can communicate in a point-to-point manner or point-to-multipoint communication.

Therefore, there is a need for a user equipment and a method for selecting a public land mobile network (PLMN).

### SUMMARY

An object of the present disclosure is to propose a user equipment and a method for selecting a public land mobile network (PLMN) capable of providing a good communication performance and high reliability.

In a first aspect of the present disclosure, a user equipment for selecting a public land mobile network (PLMN) includes a memory, a transceiver, and a processor coupled to the memory and the transceiver. The processor is configured to perform a PLMN selection. The PLMN selection is configured to be used in a standalone non-public network (SNPN). The processor is configured to control the transceiver to obtain at least one mobile country code (MCC) from a wireless communication service provider according to the PLMN selection for the SNPN and control the memory to store the at least one MCC.

In a second aspect of the present disclosure, a method for selecting a public land mobile network (PLMN) includes performing a PLMN selection, wherein the PLMN selection is configured to be used in a standalone non-public network (SNPN), obtaining at least one mobile country code (MCC) from a wireless communication service provider according to the PLMN selection for the SNPN, and storing the at least one MCC.

In a third aspect of the present disclosure, a non-transitory machine-readable storage medium has stored thereon instructions that, when executed by a computer, cause the computer to perform the above method.

In a fourth aspect of the present disclosure, a terminal device includes a processor and a memory configured to store a computer program. The processor is configured to execute the computer program stored in the memory to perform the above method.

### BRIEF DESCRIPTION OF DRAWINGS

In order to more clearly illustrate the embodiments of the present disclosure or related art, the following figures will be described in the embodiments. It is obvious that the drawings are merely some embodiments of the present disclosure, a person having ordinary skill in this field can obtain other figures according to these figures without paying the premise.

FIG. 1 is a block diagram of a user equipment and a network for selecting a public land mobile network (PLMN) according to an embodiment of the present disclosure.

FIG. 2 is a flowchart illustrating a method for selecting a PLMN according to an embodiment of the present disclosure.

FIG. 3 is a block diagram of a system for wireless communication according to an embodiment of the present disclosure.

### DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Examples are enterprise networks or networks in factories where machines and robots equipped with such a non-public network (NPN) capable modem, can communication. NPNs can be either SNPNs (standalone NPNs) or non-standalone NPNs. These two types of NPNs are differentiated as follows.

The NPN is a 5G (5th Generation Mobile Communication Technology) deployed for non-public use. The NPN may be deployed as the SNPN, i.e. operated by an NPN operator and not relying on network functions provided by a PLMN, or a public network integrated NPN, i.e. a non-public network deployed with the support of a PLMN.

In an embodiment, a way a SNPN is identified is stated as a combination of a PLMN identifier (ID) and a network identifier (NID) identifying a SNPN.

The PLMN ID used for SNPNs is not required to be unique. PLMN IDs reserved for use by private networks can be used for non-public networks, for example, e.g. based on mobile country code (MCC) 999 as assigned by an update to international telecommunication union (ITU).

As for NID, the NID can support two assignment models. Locally managed NIDs are assumed to be chosen individually by SNPNs at deployment time (and may therefore not be unique). Universally managed NIDs are assumed to be globally unique.

In some embodiments, a PLMN ID includes an MCC and a MNC (MCC+MNC). Because global system for mobile communication (GSM) and the PLMN ID give that every country has its own MCC (some countries have even more than one MCC, like with USA, India, and even Germany), the MCC+MNC combination is globally unique.

Because uniqueness is necessary, in particular for mobile cell selection and camping purposes and in physical border areas where overlapping radio coverage of different PLMNs of different countries exist. In fact, in GSM, a further method of distinguishing cells of a PLMN of one country as different from cells of another neighboring country, is by the use of color codes within a base station identity code (BSIC). Two color codes are used, namely a network color code (NCC) and a base station color code (BCC). With this BSIC, mobiles then do not inadvertently camp on cells in a different country, those cells are on same frequencies.

If one single MCC (=999) is used for SNPNs, mistakes in camping on cells of different SNPNs will arise in border areas, especially if the SNPNs use the same frequencies.

In some examples, f there is SNPN_A with PLMN ID=999+123. And there is SNPN_B with PLMN ID 999+456. Whilst SNPN_A and SNPN_B are SNPNs in the same country (e.g. country X), a mobile whose HPLMN is 999+123 is unlikely to camp onto the wrong HPLMN. But if country Y has a SNPN_C and SNPN_C has PLMN ID 999+456, immediately one can see the problem that will exist for the mobile's cell selection/reselection and camping procedures. Admittedly, if SNPN_B and SNPN_C are hundreds of kilometers apart, those cell selection/reselections and camping issues are avoided, but reliance on SNPNs of same PLMN IDs being coincidentally far enough apart is hardly an engineering solution.

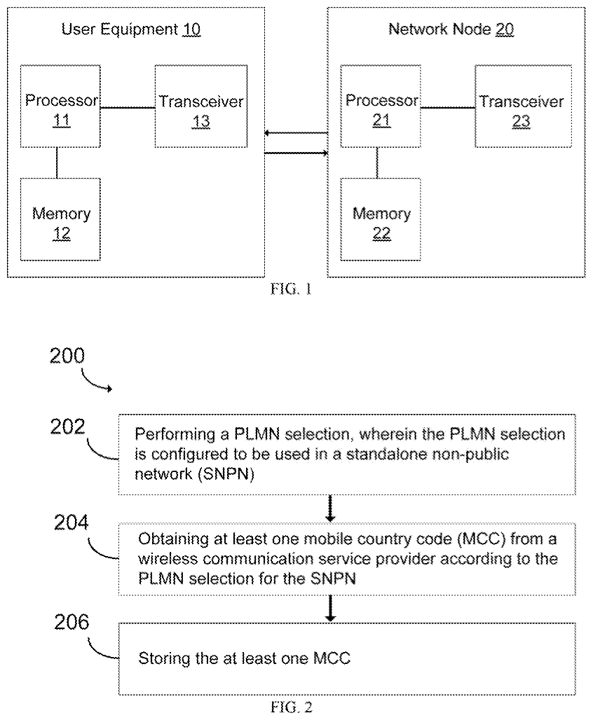

FIG. 1 illustrates that, in some embodiments, a user equipment (UE) 10 and a network node 20 for selecting a public land mobile network (PLMN) according to an embodiment of the present disclosure are provided. The UE 10 may include a processor 11, a memory 12, and a transceiver 13. The network node 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, and beyond. UEs communicate with each other directly via a sidelink interface such as a PC5 interface.

In some embodiments, the processor 11 is configured to perform a PLMN selection. The PLMN selection is configured to be used in a standalone non-public network (SNPN). The processor 11 is configured to control the transceiver 13 to obtain at least one mobile country code (MCC) from a wireless communication service provider according to the PLMN selection for the SNPN and control the memory 12 to store the at least one MCC.

In some embodiments, a minimum number of the at least one MCC is three MCCs or four MCCs. The three MCCs or the four MCCs have different colors.

In some embodiments, the processor 11 is further configured to control the transceiver 13 to obtain a color coding from the wireless communication service provider according to the PLMN selection for the SNPN. In details, the at least one MCC and the color coding are configured to be used in the SNPN. The at least one MCC is one MCC. In another embodiment, the at least one MCC is more than one MCC. The color coding may include a SNPN color code. The color coding may include a SNPN color code and at least one of a radio access network (RAN) color code, a frequency color code, and a cell color code.

In some embodiments, the PLMN is uniquely identified by a PLMN identifier (ID), and the PLMN ID includes the at least one MCC and a mobile network code. The mobile network code is 3-digit numbers. The processor 11 is further configured to control the transceiver 13 to obtain the mobile network code from the wireless communication service provider according to the PLMN selection for the SNPN.

FIG. 2 illustrates a method 200 for selecting a PLMN according to an embodiment of the present disclosure. The method 200 includes: at block 202, performing a PLMN selection, wherein the PLMN selection is configured to be used in a standalone non-public network (SNPN), at block 204, obtaining at least one mobile country code (MCC) from a wireless communication service provider according to the PLMN selection for the SNPN, and at block 206, storing the at least one MCC.

In some embodiments, a minimum number of the at least one MCC is three MCCs or four MCCs. The three MCCs or the four MCCs have different colors.

In some embodiments, the method 200 further includes obtaining a color coding from the wireless communication service provider according to the PLMN selection for the SNPN. The at least one MCC and the color coding are configured to be used in the SNPN. The at least one MCC is one MCC. In another embodiment, the at least one MCC is more than one MCC. The color coding may include a SNPN color code. The color coding may include a SNPN color code and at least one of a radio access network (RAN) color code, a frequency color code, and a cell color code.

In some embodiments, the PLMN is uniquely identified by a PLMN identifier (ID), and the PLMN ID includes the at least one MCC and a mobile network code. The mobile network code is 3-digit numbers. The method includes obtaining the mobile network code from the wireless communication service provider according to the PLMN selection for the SNPN.

In some embodiments, it can be accepted that the PLMN IDs of SNPN is globally “not required to be unique”, this method proposes that there has to be a range of MCC reserved for such non-public networks. This range of MCC may have to be requested from ITU and need to be indicated in an update to the ITU, and such request may be coordinated by 3GPP, but it is within this method that a range of MCCs can be a solution. It is noted that this method of having a range of MCCs for SNPN use does not need that range to be contiguous, nor continuous. There is no need for a maximum number to this range but there can be a minimum number such as to allow differentiation of different countries—for instance a range or a total of 250.

As an addition (or alternative) to this method, it is proposed to reserve at least 4 such MCCs e.g. 996, 997, 998, 999. This addition does not suggest that reserving four MCC codes are all that is necessary, but it does suggest that reserving four is at least a prudent (or safe alternative). The reasoning is that if one considers each of these MCCs could equate to a color, then it is a theorem in mathematics—called the four-color map theorem—that no more than four colors are needed to uniquely separate different regions or countries on a map such that no two adjacent regions or countries share the same color.

In some circles, the issue goes that a minimum of three colors are sufficient to provide such separation of geographical regions. As a further alternative we do not exclude such an issue either and would as a further alternative accept having three MCCs as a solution.

In some embodiments, just one MCC=999 is used, introduce an addition identification of color coding to ensure differentiation and separation of different countries. This color coding can be a structure on its own i.e. not part of PLMN ID nor part of network identifier (NID). This color code would then aid cell selection/reselection, allowing user equipments (UEs) of SNPNs to stay within their intended country.

As an alternative, this color coding can be part of the NID. As a construct of the NID is yet undecided, inclusion of extra field such as a color coding is not closed off. As for the number of color codes that would be required to ensure distinct separation of countries, one would follow the four-color map theorem or like GSM use of BSIC, for using 3 color coding. In this method, the color coding itself can be made up of more than one part. For instance, there can be a SNPN color code plus a frequency color code. Or for example there can be a PLMN color code, RAN color code, and frequency color code. This method does not restrict the use of different part of fields of color coding. Some examples of applying this method is given in a below table 1 (that is example structures of NID with color coding field).

TABLE 1

| Other fields and | SNPN | Frequency | Cell color | Other fields and |
|---|---|---|---|---|
| codings of NID | color code | color | code | codings of NID |
| | | code | | |
| Other fields and | SNPN color | RAN color | Other fields and | |
| codings of NID | code | code | codings of NID | |
| SNPN | Other fields and codings of NID | | | |
| color | | | | |
| code | | | | |

| | | | |
|---|---|---|---|
| Other fields and | SNPN color | Cell color | Other fields and |
| codings of NID | code | code | codings of NID |

In some embodiments, a combination of the above embodiment. I.e. applying more than just one MCC plus using a color coding. For example, Country X and Country Y share a border. In Country X, SNPN_A may have MCC MNC=997 123 and a NID that contains the color coding=abc. Then, in Country Y, a decision can be that SNPN_B has the same MNC of 123, therefore, SNPN_B may have PLMN ID (MCC MNC) of 995 123, but a color coding in the NID of 89a. In each of these two countries, there is a freedom to allocate MNC without fear of same MNC being allocated to SNPN in border areas as there is guarantee that neighboring countries may not use same MCC with the added assurance that a color code distinguishes the cells of the different networks on the two countries in the border areas.

In some embodiments, a public land mobile network (PLMN) is uniquely identified by its PLMN identifier (ID). PLMN ID consists of mobile country code (MCC) and mobile network code (MNC). The PLMN ID is made up of the MCC plus the MNC. If SNPNs are to use just one MCC regardless of the country, one way of ensuring that no two bordering countries deploying SNPNs in their respective border areas ends up with two or more SPNS having the same PLMN IDs is to ensure unique allocation of MNCs. To apply this method, those MNCs may have to be managed and allocated by international bodies such as ITU or Global System for Mobile Communications Alliance (GSMA) to ensure uniqueness in border regions of neighboring countries. SNPNs are for a common man perspective, enterprise networks, private networks. Such networks by contrast to normal PLMN operators are orders of hundreds and thousands more. Making and maintaining uniqueness of such MNCs—even if it is in specific border regions—is not a simple task. MNC is a 3-digit number—not eve alpha numeric. With three digits, one can only have nine thousand and ninety-nine unique MNCs and this is hardly enough if one considers that there will be thousands if not hundreds of thousands of such SNPNs even in relative size countries. Nevertheless, even with its limitations, this method can be a solution.

In summary, in some embodiments, it is key to PLMN selection process (automatic and manual PLMN selection procedures) that each PLMN is distinct from other PLMN by its unique MCC and MNC combination. It is also key to PLMN selection process especially selection in border areas, that each country has a MCC different from another else a UE may end up unknowingly roaming out of its home country incurring unforeseen costs to the human user. Therefore, deficiencies of using one MCC (i.e. the current suggested 999) can be overcome by the introduced methods identified in previous section of this submission. More specifically, having distinguished one country from another, a SNPN UE can then be clear that it will never select out of its own country as enterprise networks only “resident” to one country. While the embodiment can be deeming more belonging to non-access stratum (NAS), an Access Stratum (AS) may have to provide information to NAS in order to execute procedures. For instance, the AS has to provide available PLMNs to the NAS for (automatic or manual) network selection. The methods described above, could assist access atratum (AS) in the way it can scan for SNPNs and distinguish the SNPNs that are of UE's home country or else they may be networks of roamed to country.

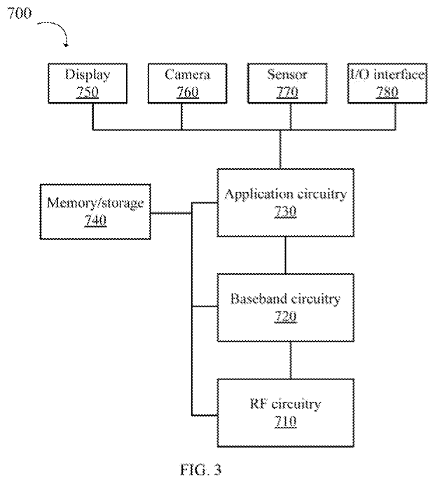

FIG. 3 is a block diagram of an example system 700 for wireless communication according to an embodiment of the present disclosure. Embodiments described herein may be implemented into the system using any suitably configured hardware and/or software. FIG. 3 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

In the embodiment of the present disclosure, a user equipment and a method for selecting a public land mobile network (PLMN) capable of providing a good communication performance and high reliability are provided. The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A user equipment for selecting a public land mobile network (PLMN), comprising:
a memory;
a transceiver; and
a processor coupled to the memory and the transceiver,
wherein the processor is configured to:
perform a PLMN selection, wherein the PLMN selection is configured to be used in a standalone non-public network (SNPN);
control the transceiver to obtain at least one mobile country code (MCC) from a wireless communication service provider according to the PLMN selection for the SNPN; and
control the memory to store the at least one MCC.

2. The user equipment of claim 1, wherein a minimum number of the at least one MCC is three MCCs or four MCCs; wherein the three MCCs or the four MCCs have different colors.

3. The user equipment of claim 1, wherein the processor is further configured to control the transceiver to obtain a color coding from the wireless communication service provider according to the PLMN selection for the SNPN.

4. The user equipment of claim 3, wherein the at least one MCC and the color coding are configured to be used in the SNPN;
wherein the at least one MCC is one MCC, or
the at least one MCC is more than one MCC.

5. The user equipment of claim 4, wherein the color coding comprises a SNPN color code.

6. The user equipment of claim 4, wherein the color coding comprises a SNPN color code and at least one of a radio access network (RAN) color code, a frequency color code, and a cell color code.

7. The user equipment of claim 4, wherein the PLMN is uniquely identified by a PLMN identifier (ID), and the PLMN ID comprises the at least one MCC and a mobile network code.

8. The user equipment of claim 7, wherein the mobile network code is 3-digit numbers.

9. The user equipment of claim 7, wherein the processor is further configured to control the transceiver to obtain the mobile network code from the wireless communication service provider according to the PLMN selection for the SNPN.

10. A method for selecting a public land mobile network (PLMN) of a user equipment, comprising:
performing a PLMN selection, wherein the PLMN selection is configured to be used in a standalone non-public network (SNPN);
obtaining at least one mobile country code (MCC) from a wireless communication service provider according to the PLMN selection for the SNPN; and
storing the at least one MCC.

11. The method of claim 10, wherein a minimum number of the at least one MCC is three MCCs or four MCCs; wherein the three MCCs or the four MCCs have different colors.

12. The method of claim 10, further comprising obtaining a color coding from the wireless communication service provider according to the PLMN selection for the SNPN.

13. The method of claim 12, wherein the at least one MCC and the color coding are configured to be used in the SNPN;
wherein the at least one MCC is one MCC, or
the at least one MCC is more than one MCC.

14. The method of claim 13, wherein the color coding comprises a SNPN color code.

15. The method of claim 13, wherein the color coding comprises a SNPN color code and at least one of a radio access network (RAN) color code, a frequency color code, and a cell color code.

16. The method of claim 13, wherein the PLMN is uniquely identified by a PLMN identifier (ID), and the PLMN ID comprises the at least one MCC and a mobile network code.

17. The method of claim 16, wherein the mobile network code is 3-digit numbers.

18. The method of claim 16, further comprising obtaining the mobile network code from the wireless communication service provider according to the PLMN selection for the SNPN.

19. A non-transitory machine-readable storage medium having stored thereon instructions that, when executed by a computer, cause the computer to perform the method of claim 10.

20. A terminal device, comprising: a processor and a memory configured to store a computer program, wherein the processor is configured to execute the computer program stored in the memory to:
perform a PLMN selection, wherein the PLMN selection is configured to be used in a standalone non-public network (SNPN);
obtain at least one mobile country code (MCC) from a wireless communication service provider according to the PLMN selection for the SNPN; and
store the at least one MCC.
